(19) United States
(12) Patent Application Publication
(10) Pub. No.: US 2014/0116949 A1
(43) Pub. Date: May 1, 2014

(54) ADSORBENT COMPOSITION BY A GREEN PROCESS AND A PROCESS FOR TOXIC METAL ION REMOVAL

(71) Applicant: GENERAL ELECTRIC COMPANY, Schenectady, NY (US)

(72) Inventors: Chithra P, Bangalore (IN); Seethalakshmi Suresh, Bangalore (IN); Shalini T, Bangalore (IN); Kaylan Das, Bangalore (IN)

(73) Assignee: GENERAL ELECTRIC COMPANY, Schenectady, NY (US)

(21) Appl. No.: 13/664,780

(22) Filed: Oct. 31, 2012

(51) Int. Cl. B01J 20/20; C02F 1/62; C02F 1/28; B01J 20/02; B01J 20/14

(52) U.S. Cl. 210/669; 502/406; 210/681; 210/688

(57) ABSTRACT

An adsorbent composition of a carrier coated with nanoparticles of zerovalent iron (“NZVI”) is disclosed. The NZVI are synthesized in situ using a tannin extract. Methods of making the adsorbent composition comprise providing a liquid stream; dispersing iron salts in the liquid stream to form an iron salt solution; adding a carrier to the iron salt solution to form a prepared stream; adding a tannin extract to the prepared stream to form a reaction stream; and forming the adsorbent composition in the reaction stream. Methods of reducing toxic metal ions in an aqueous stream are also disclosed. The methods comprise providing said aqueous stream; providing an adsorbent composition having a carrier coated with in situ nanoparticles of zerovalent iron (“NZVI”) therein; and contacting the aqueous stream with the adsorbent composition.

### FIELD OF THE INVENTION

The present invention relates to adsorbent compositions as well as manufacturing methods and uses of such compositions. More particularly, the adsorbent compositions may be used to remove heavy metals from aqueous streams.

### BACKGROUND OF THE INVENTION

Industrial and mining wastewater may be contaminated with heavy metals toxic to humans, marine animals, and wildlife. These heavy metals may be dangerous even at trace, or low concentrations and do not naturally degrade. Legislation restricts the amount of heavy metals that may be present in wastewater streams. Removal of even trace amounts of heavy metals, however, may be costly or use chemicals that must also be removed to render the water safe for human consumption or release to the environment.

Nanoparticles of zerovalent iron (“NZVI”) may be used to reduce heavy metals in remediating water. Nanoparticle synthesis, however, typically uses expensive and strong reducing agents like sodium borohydride and lithium aluminum hydride to reduce the metal ions. Nanoparticle synthesis also typically uses capping agents to stop the growth of the nanoparticles and prevent the nanoparticles from agglomerating. Typical capping agents include polymers like poly(vinyl pyrrolidone), poly vinyl alcohol, cetyltrimethyl ammonium bromide, oleic acid, polyacids, mercaptoalkanoates and oxybenzoic acids. These reducing and capping agents add cost and complexity to the nanoparticle synthesis process.

### BRIEF DESCRIPTION OF THE INVENTION

Accordingly a novel nanoparticle synthesis method is disclosed wherein tannin extract is used as both a reducing and capping agent. The method is for preparing an adsorbent composition, the method comprising in situ synthesis of nanoparticles of zerovalent iron followed by coating a carrier with the in situ synthesized zerovalent iron. The adsorbent composition may be used to reduce heavy metals in aqueous streams such as drinking water and industrial wastewater. The method is environmentally friendly, relatively inexpensive, and less complex than many current nanoparticles synthesis methods.

In one embodiment, the method may comprise providing a liquid stream and dispersing iron salts in the liquid stream to form an iron salt solution. Suitable iron salts include, but are not limited to iron(III) chloride (FeCl₃), iron(III) nitrate (Fe(NO₃)₃), iron(III) acetate (Fe(OH)(C₂H₃O₂)₂), and iron(III) oxalate (Fe(C₂O₄)₃). Suitable liquid streams include aqueous liquids. In one embodiment, the aqueous liquid may be water.

A carrier may then be added to the iron salt solution to form a prepared stream. The prepared stream may be stirred at room temperature for about 30 minutes to disperse the carrier and iron salts in the prepared stream. Suitable carrier materials include diatomite, fly-ash, silica gel, activated carbon, and rice husk ash. In one embodiment, the carrier may be diatomite. The diatomite may be calcined or raw diatomite.

Tannin extract may then be added to the prepared stream to form a reaction stream. The reaction stream may then be mixed at room, or ambient, temperature from about 1 to about 12 hours. Alternatively, the reaction stream may be mixed from about 3 to about 6 hours. Individual particles of the carrier may then be coated with NZVI as the NZVI are synthesized in situ in the reaction stream. The result is an adsorbent composition comprising carrier particles coated with in situ NZVI.

The reaction stream may then be filtered to obtain a retentate wherein the retentate comprises the adsorbent composition. The method may further comprise washing the retentate with wash water during the filtration step to remove free NZVI and other contaminants. The wash water that passes through the filter, or filtrate, may be monitored for pH, ionic conductivity, and iron content. In another method embodiment, an adsorbent bed is formed by adding rice husk ash to the adsorbent composition comprising carrier particles coated with in situ NZVI.

In other embodiments, an adsorbent composition is disclosed. The adsorbent composition comprises a carrier coated with nanoparticles of zerovalent iron, wherein the NZVI were synthesized in situ using a tannin extract. Suitable carriers include diatomite, fly-ash, silica gel, activated carbon, and rice husk ash. The diatomite may be calcined or raw diatomite. In yet other embodiments, the adsorbent composition may further comprise rice husk ash.

In another method embodiment, a method of reducing toxic metal ions from an aqueous stream is disclosed. The method comprises providing an aqueous stream; providing an adsorbent composition, wherein the adsorbent composition comprises a carrier coated with nanoparticles of zerovalent iron and wherein the NZVI were synthesized in situ using a tannin extract; and contacting the aqueous stream with the adsorbent composition. Suitable carriers include diatomite, fly-ash, silica gel, activated carbon, and rice husk ash. In another method embodiment, the carrier may be calcined or raw diatomite.

In yet other method embodiments, the adsorbent composition further comprises rice husk ash. The toxic metal ions reduced may include, but are not limited to, arsenic, lead, mercury and chromium ions.

In another method embodiment, the method may further comprise subjecting the aqueous stream to a pre-treatment step before contacting the aqueous stream with the adsorbent composition. The aqueous stream may be pre-treated to reduce the amount of any suspended particles or microorganisms therein.

### BRIEF DESCRIPTION OF THE DRAWINGS

FIG. 1 is a flowchart of an embodiment of the method for making an adsorbent composition comprising in situ NZVI-coated diatomite using a tannin extract.

FIG. 2 is a flowchart of an embodiment of the method wherein an adsorbent bed is formed from NZVI-coated diatomite and rice husk ash.

FIG. 3 shows SEM images of NZVI formed by the reaction of ferric salt with tea tannin extract.

FIG. 4 shows SEM images of in situ NZVI-coated raw diatomite formed by the reaction of ferric salt with tea tannin extract.

FIG. 5 is a graph showing the removal efficiency of various metal ions using ZVNI-coated raw diatomite.

FIG. 6 is an adsorption isotherm of ZVNI-coated raw diatomite where the adsorbate is arsenic.

### DETAILED DESCRIPTION OF EXEMPLARY EMBODIMENTS

A novel nanoparticle synthesis method is disclosed wherein tannin extract is used as both a reducing and capping agent. The method is for preparing an adsorbent composition, the method comprising in situ synthesis of nanoparticles of zerovalent iron followed by coating a carrier with the in situ synthesized zerovalent iron. The adsorbent composition may be used to reduce heavy metals in aqueous streams such as drinking water and industrial wastewater. The method is environmentally friendly, relatively inexpensive, and less complex than many current nanoparticles synthesis methods.

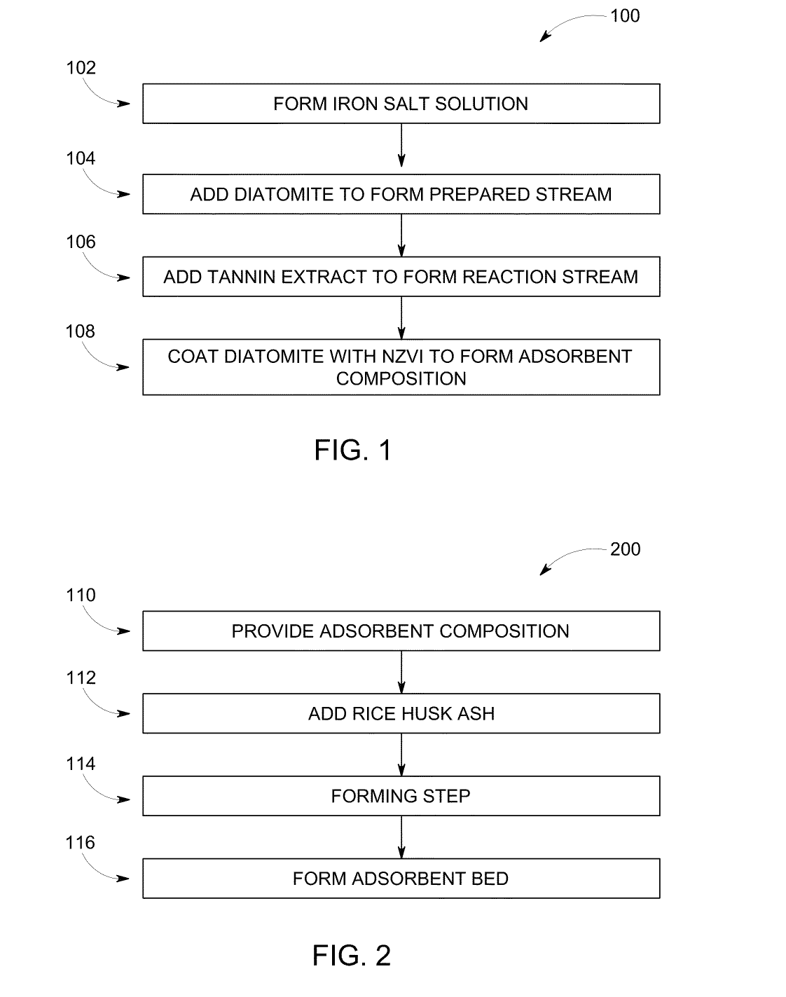

FIG. 1 is a flowchart of an embodiment of the method (100) for making an adsorbent composition comprising in situ NZVI-coated diatomite using a tannin extract (herein referred to as “NZVI-coated diatomite” or simply “coated diatomite”). The adsorbent composition comprises in situ synthesized NZVI that form a coating on diatomite. The method may comprise providing a liquid stream and dispersing iron salts in the liquid stream to form an iron salt solution (102). Suitable iron salts include, but are not limited to, iron(III) chloride (FeCl₃), iron(III) nitrate (Fe(NO₃)₃), iron(III) acetate (Fe(OH)(C₂H₃O₂)₂), and iron(III) oxalate (_{Fe}(C₂O₄)₃)_{.} Suitable liquid streams include aqueous liquids. In one embodiment, the aqueous liquid may be water.

Diatomite may then be added to the iron salt solution to form a prepared stream (104). The prepared stream may be stirred at room temperature for about 30 minutes to disperse the diatomite and iron salts in the prepared stream. The diatomite may be calcined or raw diatomite. Diatomite, also known as diatomaceous earth or kieselgur, is a naturally occurring, soft, siliceous porous material of fossilized diatoms, or algae. It usually has a particle size distribution between about 10 and about 200 microns. A typical diatomite composition is about 80-90 wt % silica, 2-4 wt % alumina, and 0.5-2 wt % iron oxide. Calcined diatomite is raw diatomite that has been heat treated to about 1000° C. to convert the diatom exoskeletons made of amorphous silica to crystallized silica. Unlike raw diatomite, calcined diatomite is considered harmful to animals and humans because of its high crystalline silica content which may be toxic if inhaled.

Raw diatomite has the added advantage in that it is more porous than calcined diatomite, thereby providing a larger surface area and pore volume that is available for coating with the in situ synthesized NZVI.

Although the embodiments in the figures and examples use diatomite as a carrier, any porous material may be used as a substrate for the in situ synthesized NZVI. Additional suitable carriers include, but are not limited to, fly-ash, silica gel, activated carbon, rice husk ash, alumina, sponges, and foams.

Tannin extract may then be added to the prepared stream to form a reaction stream (106). The reaction stream may then be mixed at room, or ambient, temperature from about 1 to about 12 hours. Alternatively, the reaction stream may be mixed from about 3 to about 6 hours. Individual particles of diatomite may then be coated with NZVI (108) as the NZVI are synthesized in situ in the reaction stream. The result is an adsorbent composition comprising particles of in situ NZVI-coated diatomite.

The weight ratios of the reactants may vary. In one embodiment, the weight ratio of diatomite (or carrier) to iron salt in the prepared stream may range from about 2:1 to about 1:2. The weight ratio of diatomite (or carrier) to tannin extract in the reaction stream may range from about 2:1 to about 1:2. In one embodiment, the ratio of diatomite to iron salt and to tannin extract may be about 1:1.1:0.5. In yet another embodiment, the ratio of diatomite to iron salt and to tannin extract may be about 1:1.1:2.

Polyphenols present in the tannin extract act as a reducing agent to convert ferric iron (iron(III) or Fe³⁺) to zerovalent iron (Fe°). The polyphenols also act as a capping agent or stabilizing agent that surround zerovalent iron particles and stop the growth of the nanoparticles as well as prevent the nanoparticles from agglomerating.

The reaction stream may then be filtered to obtain a retentate wherein the retentate comprises the adsorbent composition. The method may further comprise washing the retentate with wash water during the filtration step to remove free NZVI and other contaminants. The wash water that passes through the filter, or filtrate, may be monitored for pH, ionic conductivity, and iron content. Water that is free of contaminants, such as distilled water, is suitable for use as wash water. The retentate may be washed with fresh wash water until the monitored properties of the filtrate match those of the fresh wash water.

The manufacturing method of making the adsorbent composition comprises a green, environmentally friendly process because it uses a tannin extract, a naturally occurring, non-toxic compound found in plants. The tannin extract has polyphenols that act as both a reducing and capping agent. To solubilize the tannin extract with polyphenols, a tannin-containing plant material may be boiled in water. First, the water may be heated to about 100° C. A tannin-containing plant material may then be added to the water and boiled for 15 minutes. The weight ratio of water to tannin-containing plant material may range from about 1:5 to about 1:30. In another embodiment, the weight ratio of water to tannin-containing plant material may be about 1:20. Suitable tannin-containing plant materials include, but are not limited to, tea powder or tea leaves. Accordingly, in another embodiment, tannin extract may be obtained from tea plant material. In yet another embodiment, green tea powder may be used. The boiled material may then be filtered and the filtrate with the tannin extract comprising solubilized polyphenols may be cooled.

In another embodiment, rice husk ash may be added to the adsorbent composition such that the adsorbent composition further comprises rice husk ash (“RHA”). The ratio of coated diatomite (or carrier) to RHA may range from about 0.5:10 to about 3:10. Rice husk ash is a mesoporous substance comprised primarily of about 80% to about 90% activated silica and about 5% to about 10% activated carbon. Because of its high surface area and large pore volume, RHA by itself is a good adsorbent for suspended particles and microorganisms.

In yet another embodiment, an adsorbent bed may be formed from the adsorbent composition comprising coated diatomite and rice husk ash. FIG. 2 is a flowchart of an embodiment of the method (200) wherein an adsorbent bed is formed by adding an organic binder to the adsorbent composition. First the adsorbent composition comprising in situ NZVI-coated diatomite is provided (110). RHA may be added add to the adsorbent composition (112). For the forming step (114), the coated diatomite and RHA may be mixed in the presence of an organic binder to form adsorbent bed (116). Suitable organic binders include, but are not limited to, polyvinyl alcohol and guar gum.

In other embodiments, an adsorbent composition is disclosed. The adsorbent composition comprises a carrier coated with nanoparticles of zerovalent iron, wherein the NZVI were synthesized in situ using a tannin extract. Suitable carriers include diatomite, fly-ash, silica gel, activated carbon, and rice husk ash. The diatomite may be calcined or raw diatomite. In yet other embodiments, the adsorbent composition may further comprise rice husk ash.

In another method embodiment, a method of reducing toxic metal ions from an aqueous stream is disclosed. The method comprises providing an aqueous stream; providing an adsorbent composition, wherein the adsorbent composition comprises a carrier coated with nanoparticles of zerovalent iron and wherein the NZVI were synthesized in situ using a tannin extract; and contacting the aqueous stream with the adsorbent composition.

Suitable carriers include diatomite, fly-ash, silica gel, activated carbon, and rice husk ash. In another method embodiment, the carrier may be calcined or raw diatomite. In another method embodiment, the tannin extract may be extracted from tea plant material. In yet another method, the pH of the aqueous stream may be may range from about 2 to about 10. In yet other method embodiments, the adsorbent composition may further comprise rice husk ash. The toxic metal ions reduced may include, but are not limited to, arsenic, lead, mercury, and chromium ions.

In another method embodiment, the method may further comprise subjecting the aqueous stream to a pre-treatment step before contacting the aqueous stream with the adsorbent composition. The aqueous stream may be pre-treated to lower the amount of any suspended particles or microorganisms therein. A suitable pre-treatment step includes passing the aqueous stream through a separation device, such as a filtration, ultrafiltration, or reverse osmosis separation device.

### EXAMPLES

### Comparison of Calcined Diatomite with Raw Diatomite

For the calcined diatomite, Celite® with an average particle diameter of 68 microns was used. The surface area of calcined diatomite was measured using the BET method. The method comprised measuring the adsorption of N₂ gas on the surface of the diatomite at a constant pressure (relative pressure (P/P₀)≈0.2). The same BET measurements were repeated using raw diatomite as the adsorbant. Raw diatomite particles less than about 37 microns were used. Pore size and pore volume for both calcined and raw diatomite were also measured using the BJH method. The results of the tests are shown in Table 1 below.

TABLE 1

| | Calcined Diatomite | |
|---|---|---|
| BET/BJH Measurement | (Celite ®) | Raw Diatomite |
| Surface Area (m²/g) | 1.4898 | 76.5986 |
| Cumulative Pore Volume (m³/g) | 0.002168 | 0.289559 |
| Average Pore Diameter (A) | 89.6104 | 150.6062 |

### Preparing In Situ NZVI-Coated Raw Diatomite and Adsorption Efficacy

For the examples, tannin extract was used to synthesize nanoparticles of zerovalent iron (“NZVI”) and the NZVI were used to coat raw diatomite in-situ. The tannin extract was prepared by heating 400 mL of water to 100° C. and adding 20 grams of green tea powder to the hot water and boiling for 15 minutes. The weight ratio of water to green tea powder was 20:1. The boiled mass was then filtered and the filtrate was retained and cooled. The retained filtrate had tannin extract comprising solubilized polyphenols.

The steps of the in-situ process comprised; dispersing iron salts in a liquid to form an iron salt solution; adding diatomite to the iron salt solution to form a prepared stream; mixing the prepared stream; adding tannin extract to the prepared stream to form a reaction stream; and mixing the reaction stream at room temperature.

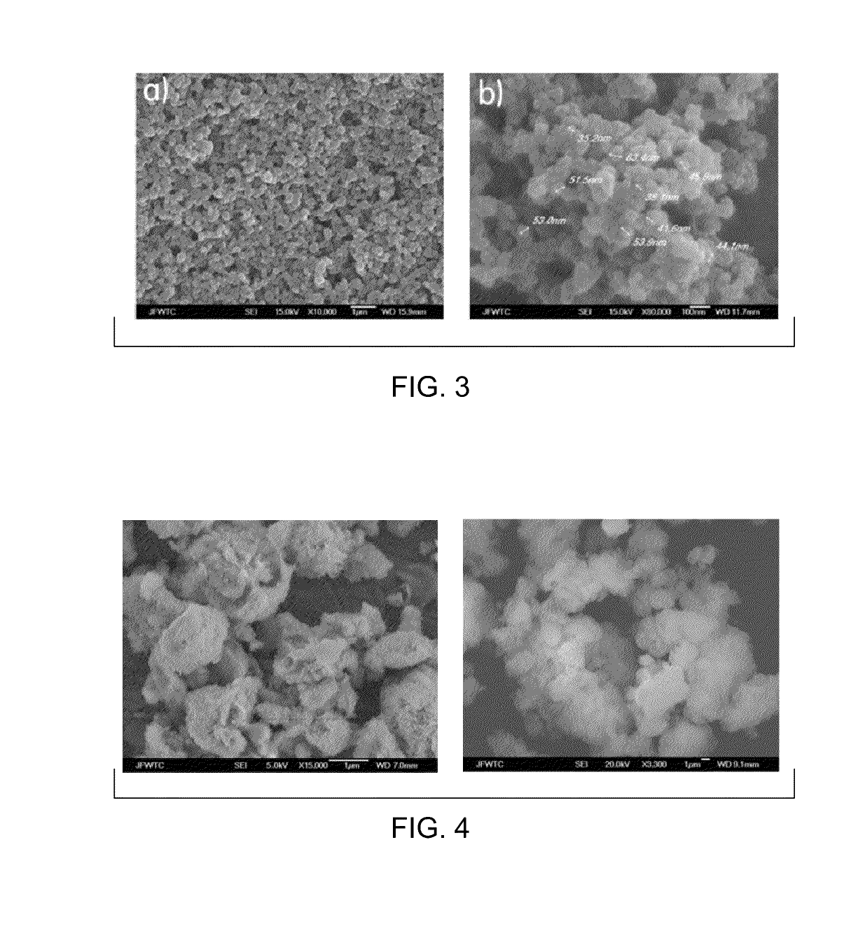

First, 12 grams of an iron salt, iron(III) chloride (FeCl₃), was dispersed in 100 mL of water to form an iron salt solution. Raw diatomite (10 grams) was then added to the iron salt solution to form a prepared stream and mixed for 30 minutes. The cooled tannin extract was then added the prepared stream to form a reaction stream. The reaction stream was then mixed for about 4 hours at room temperature. The reaction stream was then filtered to obtain a retentate. The filter was a quantitative paper filter (Whatman® grade 40-44, available from GE Healthcare). The retentate was an adsorbent composition comprising in-situ NZVI-coated diatomite (or simply “coated diatomite”). The coated raw diatomite was washed on the filter using wash water to remove excess free NZVI and other contaminants. The filtrate wash water was monitored for pH, ionic conductivity and iron content. The formed NZVI were characterized using a scanning electron microscope (“SEM”) and are shown in FIG. 3. The size of the NZVI synthesized by the green process using tea-tannin extract have a particle size ranging from about 35 nm to about 75 nm. SEM images of the retentate comprising coated raw diatomite are shown in FIG. 4.

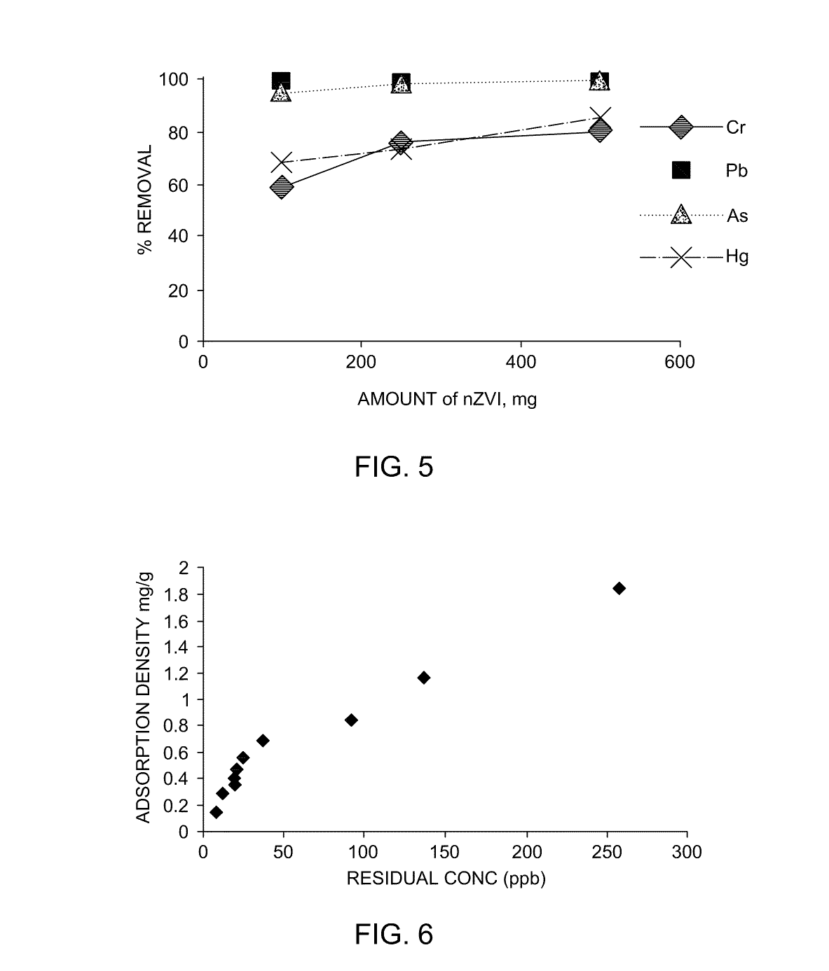

To test the efficacy of the adsorbent composition, different weights of NZVI-coated raw diatomite were placed in glass jars. Water (100 mL) suspensions prepared with known concentrations of salts containing arsenic (500 ppb), lead (500 ppb), mercury (500 ppb), and chromium (500 ppb) were added to the respective jars. The jars were shaken for 1 hour at room temperature. The contents of the jars were then filtered. The filtrates were analyzed for the residual metal ions by inductively coupled plasma mass spectrometry. The removal efficacy of the adsorbent composition comprising coated raw diatomite is summarized in Table 2 below. A graph of the removal efficacy results is shown in FIG. 5.

TABLE 2

| Amount of | | | | |
|---|---|---|---|---|
| ZNVI coated | % Cr | | | % Hg |
| diatomite (mg) | removed | % Pb removed | % As removed | removed |
| 100 | 59 | 99 | 95 | 68 |
| 250 | 75 | 99 | 98 | 73 |
| 500 | 80 | 99 | 99 | 85 |

The efficacy of the adsorbent composition was also evaluated by conducting standard adsorption experiments for arsenic (III and V), lead (II), and chromium (VI). Cr(VI) which is more toxic, gets reduced to the less toxic Cr(III) upon reaction with the NZVI in the adsorbent material.

An isotherm was also generated for arsenic and coated raw diatomite. The isotherm shows the amount of adsorbate (arsenic) on the adsorbent as a function of its concentration at a constant temperature. The adsorption isotherm results of arsenic removal efficiency of the coated raw diatomite are shown in FIG. 6.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of making an adsorbent composition, said adsorbent composition comprising a carrier coated with nanoparticles of zerovalent iron (“NZVI”), wherein said NZVI are synthesized in-situ, said method comprising:
providing a liquid stream;
dispersing at least one iron salt in said liquid stream to form an iron salt solution;
adding said carrier to said iron salt solution to form a prepared stream;
adding a tannin extract to said prepared stream to form a reaction stream; and
forming said adsorbent composition in said reaction stream.

2. The method of claim 1, further comprising stirring said reaction stream at ambient temperature for about 3 to about 6 hours.

3. The method of claim 1, further comprising filtering said reaction stream to obtain a retentate, said retentate comprising said adsorbent composition.

4. The method of claim 3, further comprising washing said retentate with wash water during said filtering step and wherein said wash water passes through said filter as filtrate.

5. The method of claim 4, further comprising monitoring at least one property of said filtrate, wherein said property is selected from the group consisting of pH, ionic conductivity, and iron content.

6. The method of claim 1, wherein said carrier is selected from the group consisting of diatomite, fly-ash, silica gel, activated carbon, and rice husk ash.

7. The method of claim 6, wherein said carrier is diatomite.

8. The method of claim 7, wherein said diatomite is raw diatomite.

9. The method of claim 8, further comprising providing rice husk ash and adding said adsorbent composition to said rice husk ash.

10. The method of claim 1, wherein said iron salt is selected from the group consisting of iron(III) chloride (FeCl₃), iron(III) nitrate (Fe(NO₃)₃), iron(III) acetate (Fe(OH)(C₂H₃O₂)₂), and iron(III) oxalate (Fe(C₂O₄)₃).

11. The method of claim 1, wherein said liquid is water.

12. The method of claim 1, wherein the tannin extract is extracted from tea plant material.

13. An adsorbent composition, said adsorbent composition comprising a carrier coated with nanoparticles of zerovalent iron (“NZVI”), wherein said NZVI were synthesized in situ using a tannin extract.

14. The adsorbent composition of claim 13, wherein said carrier is selected from the group consisting of diatomite, fly-ash, silica gel, activated carbon, and rice husk ash.

15. The adsorbent composition of claim 14, wherein said carrier is diatomite.

16. The adsorbent composition of claim 15, wherein said diatomite is raw diatomite.

17. The adsorbent composition of claim 16, wherein said adsorbent composition further comprises rice husk ash.

18. The adsorbent composition of claim 13, wherein said tannin extract is extracted from tea plant material.

19. A method of reducing toxic metal ions in an aqueous stream, said method comprising:
providing said aqueous stream;
providing an adsorbent composition, wherein said adsorbent composition comprises a carrier coated with nanoparticles of zerovalent iron (“NZVI”) and wherein said NZVI were synthesized in situ using a tannin extract; and
contacting said aqueous stream with said adsorbent composition.

20. The method of claim 19, wherein said carrier is selected from the group consisting of diatomite, fly-ash, silica gel, activated carbon, and rice husk ash.

21. The method of claim 20, wherein said carrier is diatomite.

22. The method of claim 21, wherein said diatomite is raw diatomite.

23. The method of claim 22, further comprising providing rice husk ash and adding said adsorbent composition to said rice husk ash.

24. The method of claim 19, wherein said toxic metal ions comprise at least one ion selected from the group consisting of arsenic, lead, mercury, and chromium ions.

25. The method of claim 19, wherein said tannin extract is extracted from tea plant material.

26. The method of claim 19, said method further comprising subjecting said aqueous stream to a pre-treatment step before said aqueous stream is contacted with said adsorbent composition, and wherein said pre-treatment step comprises passing said aqueous stream through a filtration device to lower the amount of any suspended particles or microorganisms therein.
